(19) United States
(12) Patent Application Publication
(10) Pub. No.: US 2009/0209328 A1
(43) Pub. Date: Aug. 20, 2009

(54) METHOD AND APPARATUS FOR A MULTI-GAME AND MULTI-LEVEL RAFFLE TICKET

(76) Inventor: Michael D. Frick, Crawfordville, FL (US)

Correspondence Address: PATENT INGENUITY, PC, 520 BROADWAY, SUITE 350, SANTA MONICA, CA, 90401, US

(21) Appl. No.: 12/034,650

(22) Filed: Feb. 20, 2008

(51) Int. Cl. A63F 9/24; A63F 13/00

(52) U.S. Cl. 463/27; 273/139; 463/17; 463/43

(57) ABSTRACT

A process indicates a first price category and a second price category in which a raffle ticket having a raffle number thereon is available for purchase. The raffle ticket is eligible for play in both an initial raffle game and a subsequent raffle game. The raffle ticket is eligible for play in both an initial raffle game and a subsequent raffle game. Further, the raffle number is utilized for play in both the initial raffle game and the subsequent raffle game. In addition, the initial raffle game occurs during an initial time period and the subsequent raffle game occurs during a subsequent time period. The initial raffle game also has an initial raffle game prize associated therewith. Further, the subsequent raffle game has a subsequent raffle prize associated therewith. The subsequent raffle game prize is less than the initial raffle game prize.

### BACKGROUND

1. Field

This disclosure generally relates to the field of gaming. More particularly, the disclosure relates to a game of chance.

2. General Background

A raffle game is a popular game of chance. Raffle players can purchase a raffle ticket to have the opportunity to win a raffle prize. The player typically does not have the opportunity to select his or her raffle number. Rather, the raffle number is selected for the player. For example, the raffle tickets can have preprinted raffle numbers or can have raffle numbers that are randomly selected for the player printed thereon at the time of purchase. A raffle number is then drawn to select a winning raffle ticket.

Raffle games typically involve raffle tickets with unique raffle numbers. As a result, current raffle games usually allow only one player to win for a particular raffle number drawn.

### SUMMARY

In one aspect of the disclosure, a process is provided. The process indicates a first price category and a second price category in which a raffle ticket having a raffle number thereon is available for purchase. The raffle ticket is eligible for play in both an initial raffle game and a subsequent raffle game. Further, the raffle number is utilized for play in both the initial raffle game and the subsequent raffle game. In addition, the initial raffle game occurs during an initial time period and the subsequent raffle game occurs during a subsequent time period. The initial raffle game also has an initial raffle game prize associated therewith. Further, the subsequent raffle game has a subsequent raffle prize associated therewith. The subsequent raffle game prize is less than the initial raffle game prize. The process also indicates, prior to purchase of the raffle ticket, a first known portion of the initial raffle prize that is won if the raffle ticket is purchased from the first price category and the raffle number is then randomly selected as a winning raffle number in the initial raffle game, and a second known portion of the initial raffle prize that is won if the raffle ticket is purchased from the second price category and the raffle number is then randomly selected as a winning raffle number in the initial raffle game. The second known portion of the initial raffle prize is less than the first known portion of the initial raffle prize. Further, the process also indicates, prior to purchase of the raffle ticket, a first known portion of the subsequent raffle prize that is won if the raffle ticket is purchased from the first price category and the raffle number is then randomly selected as a winning raffle number in the subsequent raffle game, and a second known portion of the subsequent raffle prize that is won if the raffle ticket is purchased from the second price category and the raffle number is then randomly selected as a winning raffle number in the subsequent raffle game. The second known portion of the subsequent raffle prize is less than the first known portion of the subsequent raffle prize. In addition, the process initiates play of the initial raffle game during the initial time period. The process determines whether a player having a raffle ticket with the winning raffle number in the initial raffle game is awarded the first known portion of the initial raffle prize or the second known portion of the initial raffle prize based on which price category the player purchased the raffle ticket from. Further, the process initiates play of the subsequent raffle game during the subsequent time period. Finally, the process determines whether a player having a raffle ticket with the winning raffle number in the subsequent raffle game is awarded the first known portion of the subsequent raffle prize or the second known portion of the subsequent raffle prize based on which price category the player purchased the raffle ticket from.

In another aspect of the disclosure, another process is provided. The process indicates a first price category and a second price category in which a raffle ticket having a raffle number thereon is available for purchase. The raffle ticket is eligible for play in both an initial raffle game and a subsequent raffle game. Further, the raffle number is utilized for play in both the initial raffle game and the subsequent raffle game. In addition, the initial raffle game occurs during an initial time period and the subsequent raffle game occurs during a subsequent time period. The initial raffle game has an initial raffle game prize associated therewith. Further, the subsequent raffle game has a subsequent raffle prize associated therewith. In addition, the subsequent raffle game prize is more than the initial raffle game prize. The process also indicates, prior to purchase of the raffle ticket, a first known portion of the initial raffle prize that is won if the raffle ticket is purchased from the first price category and the raffle number is then randomly selected as a winning raffle number in the initial raffle game, and a second known portion of the initial raffle prize that is won if the raffle ticket is purchased from the second price category and the raffle number is then randomly selected as a winning raffle number in the initial raffle game. The second known portion of the initial raffle prize is less than the first known portion of the initial raffle prize. Further, the process indicates, prior to purchase of the raffle ticket, a first known portion of the subsequent raffle prize that is won if the raffle ticket is purchased from the first price category and the raffle number is then randomly selected as a winning raffle number in the subsequent raffle game, and a second known portion of the subsequent raffle prize that is won if the raffle ticket is purchased from the second price category and the raffle number is then randomly selected as a winning raffle number in the subsequent raffle game. The second known portion of the subsequent raffle prize is less than the first known portion of the subsequent raffle prize. The process also initiates play of the initial raffle game during the initial time period. Further, the process determines whether a player having a raffle ticket with the winning raffle number in the initial raffle game is awarded the first known portion of the initial raffle prize or the second known portion of the initial raffle prize based on which price category the player purchased the raffle ticket from. In addition, the process initiates play of the subsequent raffle game during the subsequent time period. Finally, the process determines whether a player having a raffle ticket with the winning raffle number in the subsequent raffle game is awarded the first known portion of the subsequent raffle prize or the second known portion of the subsequent raffle prize based on which price category the player purchased the raffle ticket from.

In yet another aspect of the disclosure, another process is provided. The process indicates a first price category and a second price category in which a raffle ticket having a raffle number thereon is available for purchase. The raffle ticket is eligible for play in both an initial raffle game and a subsequent raffle game. Further, the raffle number is utilized for play in both the initial raffle game and the subsequent raffle game. The initial raffle game occurs during an initial time period and the subsequent raffle game occurs during a subsequent time period. The initial raffle game has an initial raffle game prize associated therewith. In addition, the subsequent raffle game has a subsequent raffle prize associated therewith. The subsequent raffle game prize is less than the initial raffle game prize. Further, the process indicates, prior to purchase of the raffle ticket, a first known percentage corresponding to the first price category. In addition, the process indicates, prior to purchase of the raffle ticket, a second known percentage corresponding to the second price category. Further, the process initiates play of the initial raffle game during the initial time period. The process also selects, from the first known percentage and the second known percentage, a percentage of the initial raffle game prize to be awarded to a player having a raffle ticket with the winning raffle number in the initial raffle game. Further, the process initiates play of the subsequent raffle game during the subsequent time period. Finally, the process selects, from the first known percentage and the second known percentage, a percentage of the subsequent raffle game prize to be awarded to a player having a raffle ticket with the winning raffle number in the subsequent raffle.

In another aspect of the disclosure, a process indicates a first price category and a second price category in which a raffle ticket having a raffle number thereon is available for purchase. The raffle ticket is eligible for play in both an initial raffle game and a subsequent raffle game. The raffle number is utilized for play in both the initial raffle game and the subsequent raffle game. The initial raffle game occurs during an initial time period and the subsequent raffle game occurs during a subsequent time period. The initial raffle game has an initial raffle game prize associated therewith. Further, the subsequent raffle game has a subsequent raffle prize associated therewith. The subsequent raffle game prize is more than the initial raffle game prize. In addition, the process indicates, prior to purchase of the raffle ticket, a first known percentage corresponding to the first price category. The process also indicates, prior to purchase of the raffle ticket, a second known percentage corresponding to the second price category. Further, the process initiates play of the initial raffle game during the initial time period. In addition, the process selects, from the first known percentage and the second known percentage, a percentage of the initial raffle game prize to be awarded to a player having a raffle ticket with the winning raffle number in the initial raffle game. The process also initiates play of the subsequent raffle game during the subsequent time period. Finally, the process selects, from the first known percentage and the second known percentage, a percentage of the subsequent raffle game prize to be awarded to a player having a raffle ticket with the winning raffle number in the subsequent raffle.

In yet another aspect of the disclosure, a system is disclosed. The system includes a display module that indicates a first price category and a second price category in which a raffle ticket having a raffle number thereon is available for purchase. A first known percentage corresponds to the first price category, and a second known percentage corresponds to the first price category. The raffle ticket is eligible for play in both an initial raffle game and a subsequent raffle game. Further, the raffle number is utilized for play in both the initial raffle game and the subsequent raffle game. The initial raffle game occurs during an initial time period and the subsequent raffle game occurs during a subsequent time period. The initial raffle game has an initial raffle game prize associated therewith. Further, the subsequent raffle game has a subsequent raffle prize associated therewith. The subsequent raffle game prize is less than the initial raffle game prize. The system also includes a controller that initiates play of the initial raffle game during the initial time period and selects, from the first known percentage and the second known percentage, a percentage of the initial raffle game prize to be awarded to a player having a raffle ticket with the winning raffle number in the initial raffle game, and initiates play of the subsequent raffle game during the subsequent time period and selects, from the first known percentage and the second known percentage, a percentage of the subsequent raffle game prize to be awarded to a player having a raffle ticket with the winning raffle number in the subsequent raffle game raffle game.

In another aspect of the disclosure, a system includes a display module that indicates a first price category and a second price category in which a raffle ticket having a raffle number thereon is available for purchase. A first known percentage corresponds to the first price category, and a second known percentage corresponding to the first price category. The raffle ticket is eligible for play in both an initial raffle game and a subsequent raffle game. Further, the raffle number is utilized for play in both the initial raffle game and the subsequent raffle game. The initial raffle game occurs during an initial time period and the subsequent raffle game occurs during a subsequent time period. Further, the initial raffle game has an initial raffle game prize associated therewith. In addition, the subsequent raffle game has a subsequent raffle prize associated therewith. The subsequent raffle game prize is more than the initial raffle game prize. The system also includes a controller that initiates play of the initial raffle game during the initial time period and selects, from the first known percentage and the second known percentage, a percentage of the initial raffle game prize to be awarded to a player having a raffle ticket with the winning raffle number in the initial raffle game, and initiates play of the subsequent raffle game during the subsequent time period and selects, from the first known percentage and the second known percentage, a percentage of the subsequent raffle game prize to be awarded to a player having a raffle ticket with the winning raffle number in the subsequent raffle game raffle game.

In yet another aspect of the disclosure, a computer program product comprises a computer useable medium that has a computer readable program. The computer readable program when executed on a computer causes the computer to indicate a first price category and a second price category in which a raffle ticket having a raffle number thereon is available for purchase. The raffle ticket is eligible for play in both an initial raffle game and a subsequent raffle game. Further, the raffle number is utilized for play in both the initial raffle game and the subsequent raffle game. In addition, the initial raffle game occurs during an initial time period and the subsequent raffle game occurs during a subsequent time period. The initial raffle game has an initial raffle game prize associated therewith. Further, the subsequent raffle game has a subsequent raffle prize associated therewith. In addition, the subsequent raffle game prize is less than the initial raffle game prize. The computer readable program when executed on the computer also causes the computer to indicate, prior to purchase of the raffle ticket, a first known percentage corresponding to the first price category. Further, the computer readable program when executed on the computer causes the computer to indicate, prior to purchase of the raffle ticket, a second known percentage corresponding to the second price category. In addition, the computer readable program when executed on a computer causes the computer to initiate play of the initial raffle game during the initial time period. The computer readable program when executed on the computer also causes the computer to select, from the first known percentage and the second known percentage, a percentage of the initial raffle game prize to be awarded to a player having a raffle ticket with the winning raffle number in the initial raffle game. Further, the computer readable program when executed on the computer causes the computer to initiate play of the subsequent raffle game during the subsequent time period. Finally, the computer readable program when executed on a computer causes the computer to select, from the first known percentage and the second known percentage, a percentage of the subsequent raffle game prize to be awarded to a player having a raffle ticket with the winning raffle number in the subsequent raffle game.

In another aspect of the disclosure, a computer program product comprises a computer useable medium that has a computer readable program. The computer readable program when executed on a computer causes the computer to indicate a first price category and a second price category in which a raffle ticket having a raffle number thereon is available for purchase. The raffle ticket is eligible for play in both an initial raffle game and a subsequent raffle game. Further, the raffle number is utilized for play in both the initial raffle game and the subsequent raffle game. The initial raffle game occurs during an initial time period and the subsequent raffle game occurs during a subsequent time period. The initial raffle game has an initial raffle game prize associated therewith. Further, the subsequent raffle game has a subsequent raffle prize associated therewith. In addition, the subsequent raffle game prize is less than the initial raffle game prize. The computer readable program when executed on the computer also causes the computer to indicate, prior to purchase of the raffle ticket, a first known percentage corresponding to the first price category. Further, the computer readable program when executed on the computer causes the computer to indicate, prior to purchase of the raffle ticket, a second known percentage corresponding to the second price category. In addition, the computer readable program when executed on the computer causes the computer to initiate play of the initial raffle game during the initial time period. The computer readable program when executed on the computer also causes the computer to select, from the first known percentage and the second known percentage, a percentage of the initial raffle game prize to be awarded to a player having a raffle ticket with the winning raffle number in the initial raffle game. Further, the computer readable program when executed on the computer causes the computer to initiate play of the subsequent raffle game during the subsequent time period. Finally, the computer readable program when executed on the computer causes the computer to select, from the first known percentage and the second known percentage, a percentage of the subsequent raffle game prize to be awarded to a player having a raffle ticket with the winning raffle number in the subsequent raffle game.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates an example of a multi-game and multi-level raffle display.

FIG. 2 illustrates an example of a multi-game and multi-level raffle display for a cycle of iterations of raffle games.

FIG. 3 illustrates the example of the multi-game and multi-level raffle display 200 for the cycle of iterations of raffle games shown in FIG. 2 with additional features.

FIG. 4 illustrates a process that may be utilized to provide a multi-game and multi-level raffle configuration.

FIG. 5 illustrates a multi-game and multi-level raffle display system.

FIG. 6 illustrates a multi-game and multi-level raffle ticket dispensing machine.

### DETAILED DESCRIPTION

A method and apparatus are disclosed for a multi-game and multi-level raffle ticket. Player excitement is generated as a result of providing a raffle ticket that may be utilized to play multiple raffle games such that each game occurs during a different time period and has a different prize from the other respective raffle games. Further, different portions of a raffle prize in each raffle game may be won based on the price category for which a raffle game ticket is purchased. The multi-game and multi-level raffle ticket may be a printed paper ticket, an electronic communication, or any other medium that provides the raffle number to the raffle player. In one embodiment, the same raffle number may be utilized for all of the raffle games for which the raffle ticket is purchased. Further, multiple wagers may be printed as a single paper ticket. In an alternative embodiment, different raffle numbers are utilized for the different raffle games for which the raffle ticket is purchased.

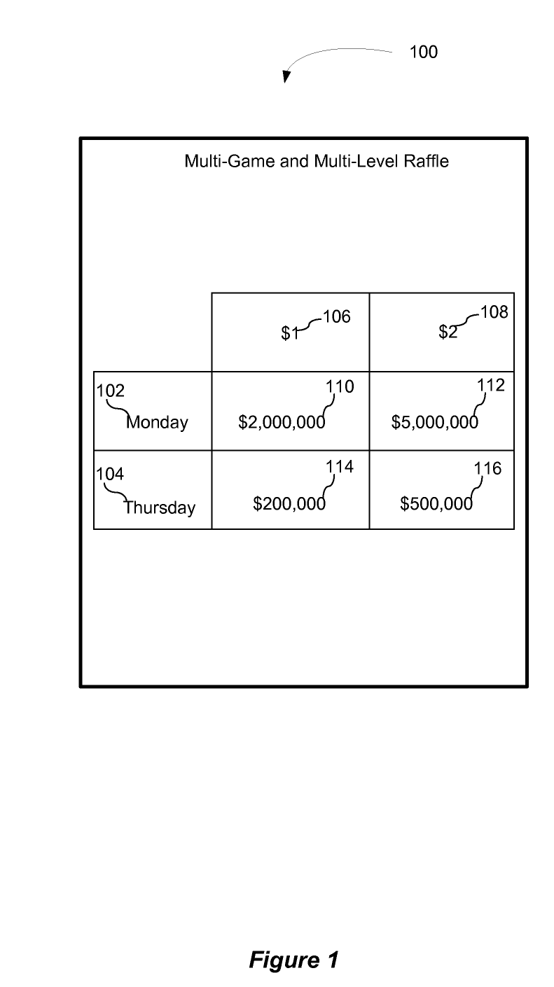

FIG. 1 illustrates an example of a multi-game and multi-level raffle display 100. A potential raffle player may view the multi-game and multi-level raffle display 100 prior to purchasing a raffle ticket for the multi-game and multi-level raffle. Accordingly, the potential player can then see that the purchase of the multi-game and multi-level raffle ticket allows entry into multiple raffle games and that the prize distribution for each raffle game is based on the price category from which the player purchases the multi-game and multi-level raffle ticket.

In one embodiment, the multi-game and multi-level raffle display 100 indicates at least a first price category and a second price category from which the multi-game and multi-level raffle ticket may be purchased. The first price category may be less than the second price category. By purchasing a multi-game and multi-level raffle ticket, the player obtains a raffle number that is eligible for both an initial raffle game and a subsequent raffle game. The initial raffle game occurs during an initial time period whereas the subsequent raffle game occurs during a subsequent time period. These time periods may be any periods of time that are distinct. For example, the periods of time may be seconds, minutes, hours, days, weeks, months, years, etc. In one embodiment, these periods of time do not overlap. Further, each period of time has a distinct prize associated therewith. For example, an initial raffle game may have larger prize than the subsequent raffle game. In addition, a player with a winning raffle number for a raffle game corresponding to a particular period wins only the known portion corresponding to the price category for which the multi-game and multi-level raffle ticket 100 was purchased. For instance, the highest price category may be associated with the entire known portion of the raffle prize for a given period whereas a lower price category may be associated with less than the entire known portion of the raffle prize for the given time period.

The example of the multi-game and multi-level raffle display 100 shown in FIG. 1 indicates an initial time period 102 of Monday and a subsequent time period 104 of Thursday. The initial time period 102 and the subsequent time period may or may not be consecutive time periods. In other words, the subsequent time period 104 could be Tuesday instead of Thursday. Further, the example of the multi-game and multi-level raffle display 100 indicates a first price category 106 of one dollar and a second price category 108 of two dollars. In addition, the example of the multi-game and multi-level raffle display 100 indicates an initial raffle prize 112 and a subsequent raffle prize 116. For example, the initial raffle prize 112 of five million dollars can be won if the raffle number on the multi-game and multi-level raffle ticket is a winning raffle number for the initial raffle game on Monday. The subsequent raffle prize 116 of five hundred thousand dollars can be won if the raffle number on the multi-game and multi-level raffle ticket is a winning raffle number for the subsequent raffle game on Thursday. The actual prize distribution to player with the winning raffle number depends on the price category from which the player purchased the multi-game and multi-level raffle ticket. For example, if the player purchased the multi-game and multi-level raffle ticket from the second price category 108, i.e., the two dollar price category, then the player can win the entire portion of the initial raffle prize 112, e.g., five million dollars, or the entire portion of the subsequent raffle prize 116, e.g., five hundred thousand dollars. However, if the player purchased the multi-game and multi-level raffle ticket from the first price category 106, i.e., the one dollar price category, then the player can win only win a fractional portion 110, e.g., two million dollars, of the initial raffle prize of five million dollars, or a fractional portion 114, e.g., two hundred thousand dollars, of the subsequent raffle prize of five hundred thousand dollars.

The portions may be indicated in other formats other than numerical values. For instance, percentages may be utilized. As an example, the fractional portion 110 and the fractional portion 114 may be indicated as forty percent where as the entire portion of the initial raffle prize 112 and the entire portion of the subsequent raffle prize 116 may be indicated as one hundred percent.

In an alternative embodiment, the portions may differ for the different time periods. For example, the fractional portion 110 may equate to thirty percent whereas the fractional portion 114 may equate to fifty percent. In yet another alternative embodiment, separate price categories may be utilized for the different games. For example, the initial game may have a first price category and second price category, and the subsequent game may have a first price category and a second price category. The player then has the ability to choose a higher price category for one game and a lower price category for another game. The total of the different price categories selected by the player is then reflected in the total multi-game and multi-level raffle ticket price.

The initial raffle prize and the subsequent raffle prize may be fixed prizes, progressive prizes, or probabilistic jackpot prizes. These prizes may be cash prizes or non-cash prizes such as merchandise prizes, travel prizes, merchandise cards, merchandise certificates, or the like. Further, the initial raffle prize may or may not be a different type of prize than the subsequent raffle prize. For example, the initial raffle prize and the subsequent raffle prize may both be fixed prizes, or the initial prize may be a fixed prize while the subsequent raffle prize is a progressive prize. Combinations and sub-combinations of raffle prize types are contemplated within this disclosure.

In one embodiment, the raffle number on the multi-game and multi-level raffle ticket is a unique number that is distinct from any other number on any other multi-game and multi-level raffle ticket. As a result, there is only one winner per raffle number drawn. Therefore, the raffle player does not have to share his or her winnings as may be necessary in a lottery drawing, which allows for multiple lottery tickets to have the same winning lottery numbers. In one embodiment, the raffle number on the multi-game and multi-level raffle ticket is selected from a predetermined range. For example, the raffle number may be selected from the numbers one through one hundred thousand. Accordingly, preprinted tickets that each have a number selected from this range may be provided to raffle operators for sale to raffle ticket purchasers. Alternatively, raffle operators may be able to select from available raffle numbers in the predetermined range. As a result, the player may have the option to select his or her own raffle number if that raffle number is still available. In either of these configurations, the raffle number may be randomly selected from the predetermined range for the player. For example, a random number generator may be utilized make this random selection.

In another embodiment, the raffle number is selected from a range that is unpredetermined, i.e., not predetermined. Accordingly, any unique number may be selected. In one configuration, although the range is not predetermined, a finite quantity of multi-game and multi-level raffle tickets may be sold. For example, a ticket may have the raffle number two hundred thousand thereon, but only one hundred thousand tickets may be sold. Therefore, some number between one and one hundred thousand will not appear on one of the tickets. By providing a finite limit on the quantity of multi-game and multi-level raffle tickets sold, the player has a clear idea of the odds of winning for each time a raffle number is drawn. As a result, the player may be more induced to purchase a multi-game and multi-level raffle ticket.

In one embodiment, the multi-game and multi-level raffle configuration as discussed above can be implemented with a constant ratio based system. For example, a raffle player can purchase a one dollar ticket in the hope of winning a raffle distribution of two million dollars. The raffle player can also purchase a two dollar ticket in the hope of winning a raffle distribution of four million dollars. A first association between the first price category of one dollar and the distribution of two million dollars can be the quotient of two million divided by one, which equals two million. Similarly, a second association between the second price category of two dollars and the distribution of four million dollars can be the quotient of four million divided by two, which equals two million. A constant ratio exists when the first association equals the second association. In one embodiment, a raffle player can purchase one two dollar ticket as opposed to two one dollar tickets to avoid having to purchase multiple tickets.

In another embodiment, the multi-game and multi-level raffle configuration as discussed above can be implemented to induce the purchase of higher priced raffle tickets. For example, a raffle player can purchase a one dollar ticket in the hope of winning a raffle distribution of two million dollars. The raffle player can also purchase a two dollar ticket in the hope of winning a raffle distribution of five million dollars. The first association equals two million (two million divided by one) and the second association equals two and one half million (five million divided by two). A variable ratio exists because the first association does not equal the second association. In one embodiment, this variable ratio provides the raffle player with incentive to purchase a two dollar ticket. In one embodiment, the raffle player can purchase the two dollar ticket as opposed to two one dollar tickets because the potential distribution is greater by purchasing the two dollar ticket as opposed to the two one dollar tickets.

The raffle prize payout for the initial raffle prize and/or the subsequent raffle prize may be guaranteed by a third party entity. As a result, a raffle provider may be able to provide a larger raffle prize than might otherwise be the case.

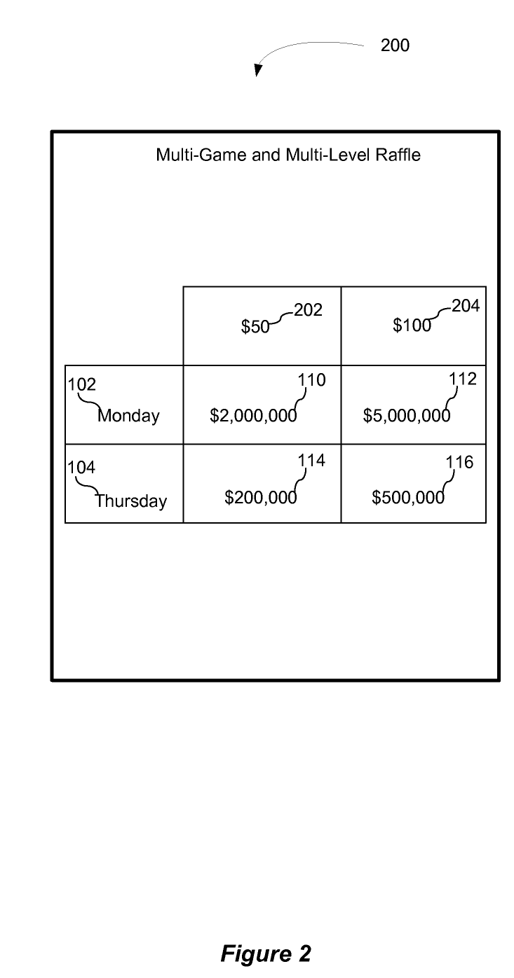

FIG. 2 illustrates an example of a multi-game and multi-level raffle display 200 for a cycle of iterations of raffle games. While the multi-game and multi-level raffle ticket may be provided for a single initial raffle game and a single subsequent game, as shown in FIG. 1, the multi-game and multi-level raffle ticket may also be provided for multiple iterations of the initial raffle game and the subsequent game over the corresponding time periods. For example, a raffle number may be drawn for the initial raffle game that may occur on every Monday of the year and a raffle number may be drawn for the subsequent raffle game that may occur on every Thursday of the year. The multi-game and multi-level raffle ticket may then be sold to a raffle player for a cycle of fifty two iterations of initial and subsequent games. The raffle player then has the ability to purchase a single raffle ticket that is eligible for the initial game prize 112, e.g., five million dollars, or a portion therefore during any of the initial time periods during the year (e.g., any Monday during the year) and the subsequent game prize 116, or a portion thereof during any of the subsequent timer periods during the year (e.g., any Thursday during the year).

The first price category and the second price category are larger for a cycle as opposed to a single iteration of an initial an subsequent game. As an example, the first price category for the cycle may be fifty dollars whereas the second price category for the cycle may be one hundred dollars. The constant ratio or variable ratio configurations discussed above may be utilized for the pricing structure and prize structure of the multi-game and multi-level raffle implementation having a cycle.

In an alternative embodiment, the multi-game and multi-level raffle ticket may be provided for multiple iterations of the initial game and/or subsequent game. For example, a ticket may be sold to a player that would like to participate in the initial game every Monday of the year, but only once or some other subset less than a year of Thursdays for the subsequent game.

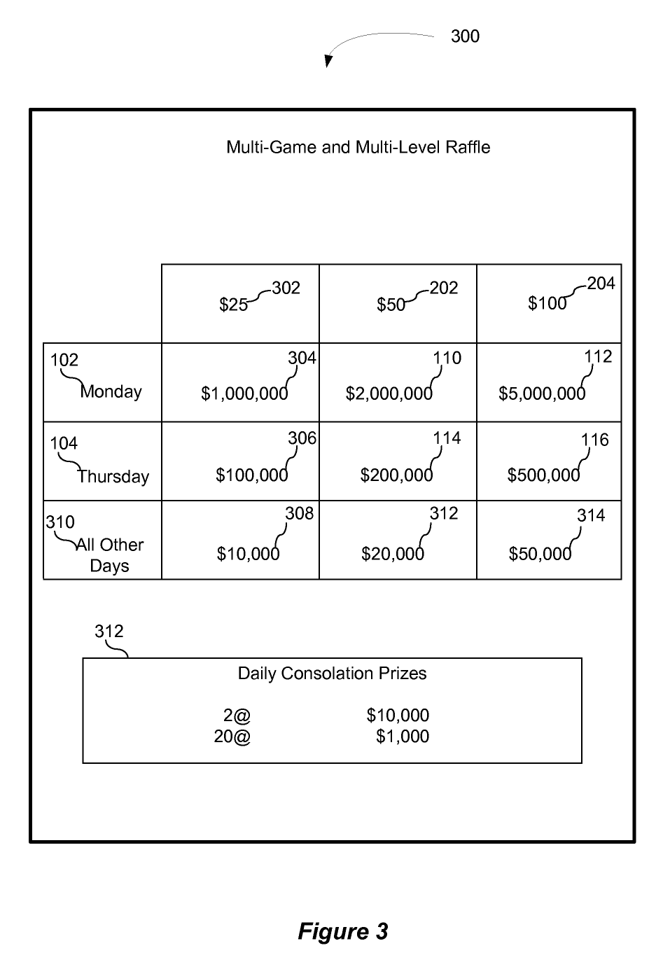

FIG. 3 illustrates the example of the multi-game and multi-level raffle display 200 for the cycle of iterations of raffle games shown in FIG. 2 with additional features. One additional feature is an additional price category 302 of twenty five dollars for the ability to win a one fifth portion 304 of the initial raffle prize of five million dollars equaling one million dollars and the ability to win a one fifth portion 306 of the subsequent raffle prize of five hundred thousand dollars equaling one hundred thousand dollars.

Another additional feature is that additional raffle numbers may be drawn during time periods other than the initial time period and the subsequent time period. Some of these additional periods may be intervening time periods between the initial time period and the subsequent time period or intervening time periods between the subsequent time period and the next initial time period. As an example, these additional time periods 310 may be characterized as all other days, e.g., Tuesday, Wednesday, Friday, Saturday, and Sunday. On each of these other days, the raffle prize 314 may be fifty thousand dollars. Further, a player with a winning raffle number who purchased the raffle ticket form the additional price category 302 of twenty five dollars may win a one fifth portion 308 of the fifty thousand dollar raffle prize 314 equaling ten thousand dollars. A player with a winning raffle number who purchased the raffle ticket form the first price category 202 of fifty dollars may win a two fifths portion 312 of the fifty thousand dollar raffle prize 314 equaling twenty thousand dollars. Finally, a player with a winning raffle number who purchased the raffle ticket form the second price category 314 of one hundred dollars may win the entire portion of the fifty thousand dollar raffle prize 314 equaling ten thousand dollars.

Yet another additional feature is daily consolation prizes. Additional raffle numbers may be drawn in a given time period to provide a raffle player with the opportunity to win a lesser prize than the main prize. For example, after the number for the main raffle is drawn in a given time period, e.g., the raffle number that is drawn for the five million dollar prize on Monday, two additional raffle numbers are drawn that each have a consolation prize of ten thousand dollars and twenty raffle numbers are drawn that each have a consolation prize of one thousand dollars may be performed. In one embodiment, the consolation prizes are the same amount for the different time periods. In another embodiment, the consolation prizes are different amounts for the different time periods.

In an alternative embodiment, the known portion of a raffle prize that can be won may adjust during later iterations of a particular time period in the cycle. For example, a raffle ticket purchased form the first price category 202 may provide a player with the ability to win a two-fifths portion 110 of the initial raffle prize of five million dollars equaling two million dollars for the Mondays occurring in the first half of the year and a three-fifths portion of the initial raffle prize of five million dollars equaling three million dollars for the Mondays occurring in the second half of the year.

In yet another alternative embodiment, a winner may longer be eligible to win a portion of a prize for a particular time period in the cycle if the winner has already won a portion of a raffle prize during the cycle. For example, if a player who purchases the multi-game and multi-level raffle ticket from the first price category 202 of fifty dollars wins two million dollars on the first Monday of the year, that player will no longer be eligible to win the two million dollars on any of the other Mondays in the year. In one configuration, the limitation on eligibility is raffle number specific so that a player who purchases more than one multi-game and multi-level raffle ticket and wins on the first Monday with one raffle number is still eligible to win on the other Mondays in the year with the other raffle numbers on the other multi-game and multi-level raffle tickets. In another configuration, a win in a given time period does not affect eligibility for other time periods. In the example above, a player winning on Monday may no longer be eligible to win on the remaining Mondays of the year, but still has the ability to win on the remaining Thursdays and all other days of the year.

Any of the configurations described above may be utilized in a single jurisdictional or a multi-jurisdictional raffle game. The term jurisdiction is intended to mean town, city, state, province, country, etc. The multi-jurisdictional raffle game may allow for larger raffle prizes than the single jurisdictional raffle game based on the larger number of potential raffle players. In one embodiment, a third party entity or a selected jurisdiction administers the multi-jurisdictional raffle game. The entity that administers the multi-jurisdictional raffle game may select particular ranges of raffle numbers to be provided to designated jurisdictions for sale in those designated jurisdictions. For example, raffle tickets with raffle numbers in the range of one through one million may be designated for a first state, raffle tickets with raffle numbers in the range of one million one through two million may be designated for a second state, and raffle tickets with raffle numbers in the range of two million one through three million may be designated for a third state. As the raffle number is drawn by a random selection, no particular jurisdiction is favored. In an alternative embodiment, operators in each jurisdiction may have a computer system that determines the availability of raffle numbers prior to sale. The computer system may communicate with a centralized database. If a raffle number is available, the computer system of the operator may print out that raffle number on a raffle ticket. The computer system may look for the next available number, or may look for a number that the potential raffle purchaser would like to have.

In one embodiment, the multi-game and multi-level raffle game may have a multi-jurisdictional component and a single jurisdictional component. For example, the initial raffle game may be provided in an initial time period, e.g., Monday, throughout multiple jurisdictions, but the subsequent raffle game may be provided locally in the local jurisdictions in a subsequent time period, e.g., Thursday.

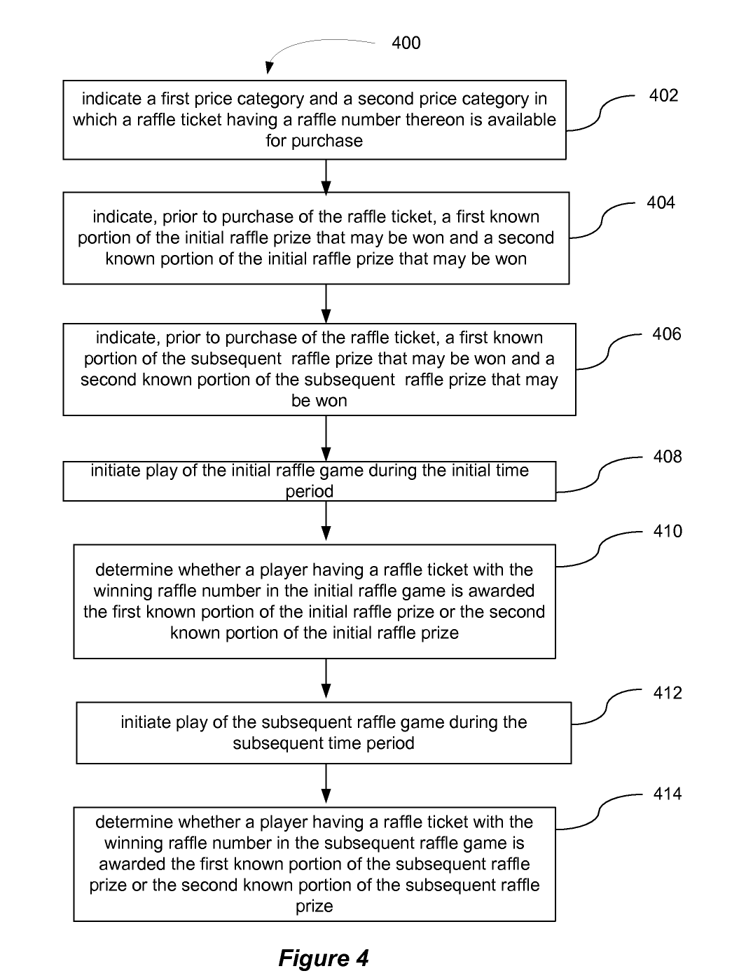

FIG. 4 illustrates a process 400 that may be utilized to provide a multi-game and multi-level raffle configuration. At a process block 402, the process 400 indicates a first price category and a second price category in which a raffle ticket having a raffle number thereon is available for purchase. The raffle ticket is eligible for play in both an initial raffle game and a subsequent raffle game. The raffle number is utilized for play in both the initial raffle game and the subsequent raffle game. The initial raffle game occurs during an initial time period, and the subsequent raffle game occurs during a subsequent time period. The initial raffle game has an initial raffle game prize associated therewith. The subsequent raffle game has a subsequent raffle prize associated therewith. In one embodiment, the subsequent raffle game prize is less than the initial raffle game prize. In another embodiment, the subsequent raffle game prize is more than the initial raffle game prize.

Further, at a process block 404, the process 400 indicates, prior to purchase of the raffle ticket, a first known portion of the initial raffle prize that is won if the raffle ticket is purchased from the first price category and the raffle number is then randomly selected as a winning raffle number in the initial raffle game, and a second known portion of the initial raffle prize that is won if the raffle ticket is purchased from the second price category and the raffle number is then randomly selected as a winning raffle number in the initial raffle game. The second known portion of the initial raffle prize is less than the first known portion of the initial raffle prize.

In addition, at a process block 406, the process 400 indicates, prior to purchase of the raffle ticket, a first known portion of the subsequent raffle prize that is won if the raffle ticket is purchased from the first price category and the raffle number is then randomly selected as a winning raffle number in the subsequent raffle game, and a second known portion of the subsequent raffle prize that is won if the raffle ticket is purchased from the second price category and the raffle number is then randomly selected as a winning raffle number in the subsequent raffle game. The second known portion of the subsequent raffle prize is less than the first known portion of the subsequent raffle prize.

At a process block 408, the process 400 initiates play of the initial raffle game during the initial time period. Further, at a process block 410, the process 400 determines whether a player having a raffle ticket with the winning raffle number in the initial raffle game is awarded the first known portion of the initial raffle prize or the second known portion of the initial raffle prize based on which price category the player purchased the raffle ticket from. In addition, at a process block 412, the process 400 initiates play of the subsequent raffle game during the subsequent time period. Finally, at a process block 414, the process 400 determines whether a player having a raffle ticket with the winning raffle number in the subsequent raffle game is awarded the first known portion of the subsequent raffle prize or the second known portion of the subsequent raffle prize based on which price category the player purchased the raffle ticket from.

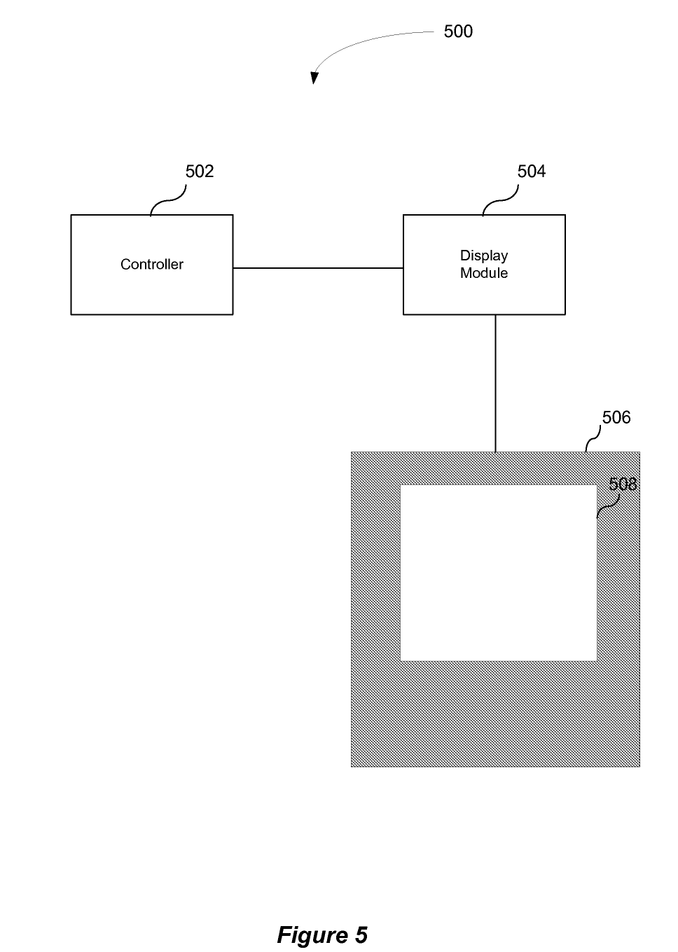

FIG. 5 illustrates a multi-game and multi-level raffle display system 500. The multi-game and multi-level raffle display system 500 includes a controller 502, a display module 504, and a display unit 506. In one embodiment, the controller determines or receives data for the price categories, raffle prize amounts for the corresponding time periods, and known portions of the raffle prize amounts corresponding to the price categories. The controller 502 is operably connected to the display module 504 to provide this data to the display module. The controller 502 may be locally connected via hard wire or cable to the display module 504, or remotely connected via a network to the display module 504. The display module 504 may be hardware or software that is configured to output the data for display. In one embodiment, the display module 504 is operably connected to the display unit 506 out output this data for display on a display screen 508 of the display unit 506. The display module 504 may be locally connected via hard wire or cable to the display unit 506, or remotely connected via a network (e.g., local area network (“LAN”), wireless, or the like) to the display unit 506. The display unit 506 may be a graphical user interface (“GUI”), computer monitor, laptop monitor, television, personal digital assistant (“PDA”), cell phone, or any other electronic display unit that may be configured to receive data from the display module 504 for display. The display unit 506 may display the data in a static or animated fashion.

In an alternative embodiment, the display module 504 is operably connected to a printer rather than the display unit 506. The printer may be utilized to print out the data for display in a paper format, e.g., a sign posted at the location of a raffle vendor.

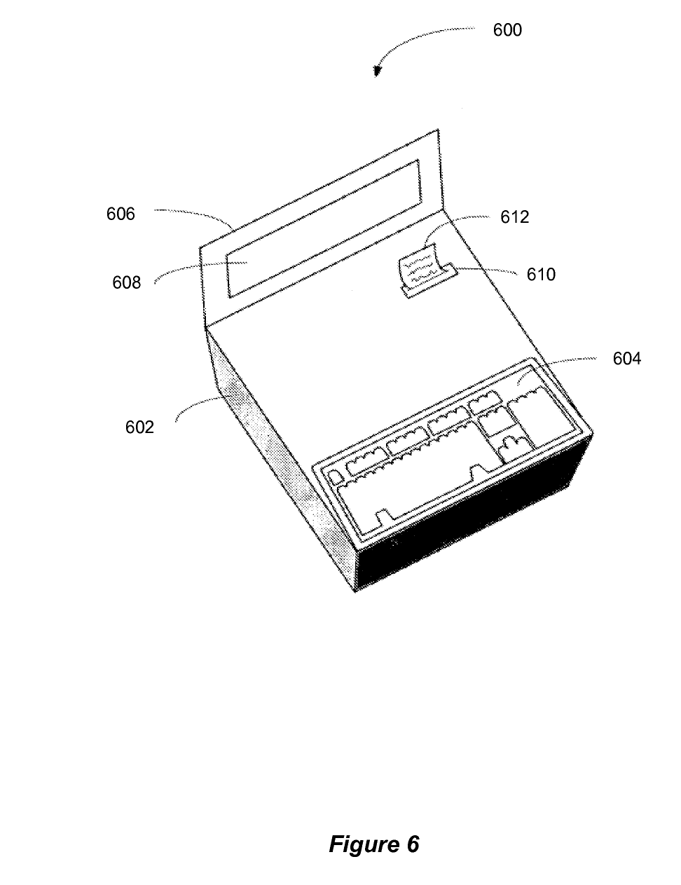

FIG. 6 illustrates a multi-game and multi-level raffle ticket dispensing machine 600. The different embodiments discussed above can be implemented with the multi-game and multi-level raffle ticket dispensing machine 600, which can be positioned at various point of sale locations, to print out multi-game and multi-level raffle tickets. The multi-game and multi-level raffle ticket dispensing machine 600 has a housing 602, which stores the internal components of the multi-game and multi-level raffle ticket dispensing machine 600. In addition, the multi-game and multi-level raffle ticket dispensing machine 600 also has a user input device 604 on which a raffle vendor can input data for the sale of a lottery ticket. For instance, the raffle vendor can input one of the different price categories in the multi-game and multi-level raffle ticket dispensing machine 600.

The price category that the vendor enters can be displayed on a screen 608 of a display 606. In one embodiment, the display 606 is a GUI. In another embodiment, the display 606 displays data other than the price categories.

The vendor can then sell tickets in the respective price categories. When a purchaser would like to purchase a raffle ticket, the vendor enters the purchase information into the multi-game and multi-level raffle ticket dispensing machine 600 via the user input device 604. In one embodiment, the user input device 604 is a keyboard. In another embodiment, the user input device 604 is operated by using a computer mouse. In an alternative embodiment, the user input device 604 is a touch screen. In yet another embodiment, the user input device 604 is voice activated. In an alternative embodiment, the display 606 displays the purchased information that is entered via the user input device 604.

In one embodiment, the multi-game and multi-level raffle ticket dispensing machine 600 has a payment reception module that receives a payment for the purchase of a raffle ticket. In another embodiment, the payment reception module receives an electronic payment.

After the vendor inputs the data needed to sell a raffle ticket from one of the selected price categories, a raffle ticket 612 is printed from a raffle ticket printer 610. In one embodiment, the raffle ticket printer 610 is housed within the housing 602. In another embodiment, the raffle ticket printer 610 is positioned outside of the housing 602 and is operably connected to the multi-game and multi-level raffle ticket dispensing machine 600. In yet another embodiment, the raffle ticket printer 610 receives data from the multi-game and multi-level raffle ticket dispensing machine 600 through a wireless connection.

In another embodiment, the multi-game and multi-level raffle ticket dispensing machine 600 is a self-service unit in which a potential raffle ticket purchaser may purchase a multi-game and multi-level raffle ticket without the assistance of a retail clerk.

The process 400 shown in FIG. 4 may be implemented in a general, multi-purpose or single purpose processor. Such a processor will execute instructions, either at the assembly, compiled or machine-level, to perform that process. Those instructions can be written by one of ordinary skill in the art following the description of FIG. 4 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

A computer is herein intended to include any device that has a general, multi-purpose, or single purpose processor as described above. For example, a computer may be a set top box (“STB”), cell phone, portable media player, or the like.

It is understood that the method and apparatus described herein may also be applied in other types of systems. Those skilled in the art will appreciate that the various adaptations and modifications of the embodiments of this method and apparatus may be configured without departing from the scope and spirit of the present method and system. Therefore, it is to be understood that, within the scope of the appended claims, the present method and apparatus may be practiced other than as specifically described herein.

I claim:

1. A method comprising:
indicating a first price category and a second price category in which a raffle ticket having a raffle number thereon is available for purchase, the raffle ticket being eligible for play in both an initial raffle game and a subsequent raffle game, the raffle number being utilized for play in both the initial raffle game and the subsequent raffle game, the initial raffle game occurring during an initial time period and the subsequent raffle game occurring during a subsequent time period, the initial raffle game having an initial raffle game prize associated therewith, the subsequent raffle game having a subsequent raffle prize associated therewith, the subsequent raffle game prize being less than the initial raffle game prize;
indicating, prior to purchase of the raffle ticket, a first known portion of the initial raffle prize that is won if the raffle ticket is purchased from the first price category and the raffle number is then randomly selected as a winning raffle number in the initial raffle game, and a second known portion of the initial raffle prize that is won if the raffle ticket is purchased from the second price category and the raffle number is then randomly selected as a winning raffle number in the initial raffle game, the second known portion of the initial raffle prize being less than the first known portion of the initial raffle prize;
indicating, prior to purchase of the raffle ticket, a first known portion of the subsequent raffle prize that is won if the raffle ticket is purchased from the first price category and the raffle number is then randomly selected as a winning raffle number in the subsequent raffle game, and a second known portion of the subsequent raffle prize that is won if the raffle ticket is purchased from the second price category and the raffle number is then randomly selected as a winning raffle number in the subsequent raffle game, the second known portion of the subsequent raffle prize being less than the first known portion of the subsequent raffle prize;
initiating play of the initial raffle game during the initial time period;
determining whether a player having a raffle ticket with the winning raffle number in the initial raffle game is awarded the first known portion of the initial raffle prize or the second known portion of the initial raffle prize based on which price category the player purchased the raffle ticket from;
initiating play of the subsequent raffle game during the subsequent time period; and
determining whether a player having a raffle ticket with the winning raffle number in the subsequent raffle game is awarded the first known portion of the subsequent raffle prize or the second known portion of the subsequent raffle prize based on which price category the player purchased the raffle ticket from.

2. The method of claim 1, wherein the initial raffle prize is a known fixed initial raffle prize and the subsequent raffle prize is a known fixed subsequent raffle prize.

3. The method of claim 1, wherein the initial raffle prize is an initial progressive prize and the subsequent raffle prize is a subsequent progressive prize.

4. The method of claim 1, wherein the initial raffle prize is an initial probabilistic jackpot prize and the subsequent raffle prize is a subsequent probabilistic jackpot prize.

5. The method of claim 1, wherein the initial raffle prize is guaranteed by a third party entity.

6. The method of claim 1, wherein the subsequent raffle prize is guaranteed by a third party entity.

7. The method of claim 1, wherein the first known portion of the initial raffle prize is a percentage of the initial raffle prize.

8. The method of claim 1, wherein the first known portion of the initial raffle prize is the entire initial raffle prize.

9. The method of claim 1, wherein the second known portion of the initial raffle prize is a percentage of the initial raffle prize.

10. The method of claim 1, wherein the first known portion of the subsequent raffle prize is a percentage of the subsequent raffle prize.

11. The method of claim 1, wherein the first known portion of the subsequent raffle prize is the entire subsequent raffle prize.

12. The method of claim 1, wherein the second known portion of the subsequent raffle prize is a percentage of the subsequent raffle prize.

13. The method of claim 1, wherein the raffle number is selected from a predetermined range and is distinct from any other raffle number on any other raffle ticket eligible for play in the initial raffle game and the subsequent raffle game.

14. The method of claim 13, wherein the raffle number is randomly selected.

15. The method of claim 14, wherein the initiating play of the initial raffle game during the initial period includes randomly selecting a raffle number from a set of raffle numbers that each correspond to one of a plurality of raffle tickets purchased.

16. The method of claim 14, wherein the initiating play of the subsequent raffle game during the subsequent period includes randomly selecting a raffle number from a set of raffle numbers that each correspond to one of a plurality of raffle tickets purchased.

17. The method of claim 1, wherein the raffle number is selected from an unpredetermined range and is distinct from any other raffle number on any other raffle ticket eligible for play in the initial raffle game and the subsequent raffle game.

18. The method of claim 1, wherein the initial time period is a day.

19. The method of claim 18, wherein subsequent time period is the next day after the day of the initial time period.

20. The method of claim 1, wherein a variable ratio exists between the first known portion of the initial raffle game and the second known portion of the initial raffle game.

21. The method of claim 1, wherein a variable ratio exists between the first known portion of the subsequent raffle game and the second known portion of the subsequent raffle game.

22. The method of claim 1, wherein a constant ratio exists between the first known portion of the initial raffle game and the second known portion of the initial raffle game.

23. The method of claim 1, wherein a constant ratio exists between the first known portion of the subsequent raffle game and the second known portion of the subsequent raffle game.

24. The method of claim 1, further comprising initiating additional iterations of play of the initial raffle game during a predetermined cycle.

25. The method of claim 24, further comprising initiating additional iterations of play of the subsequent raffle game during the predetermined cycle such that at least one of the additional iterations of play of the subsequent raffle game occurs after at least one of the additional iterations of the initial raffle game.

26. A method comprising:
indicating a first price category and a second price category in which a raffle ticket having a raffle number thereon is available for purchase, the raffle ticket being eligible for play in both an initial raffle game and a subsequent raffle game, the raffle number being utilized for play in both the initial raffle game and the subsequent raffle game, the initial raffle game occurring during an initial time period and the subsequent raffle game occurring during a subsequent time period, the initial raffle game having an initial raffle game prize associated therewith, the subsequent raffle game having a subsequent raffle prize associated therewith, the subsequent raffle game prize being more than the initial raffle game prize;
indicating, prior to purchase of the raffle ticket, a first known portion of the initial raffle prize that is won if the raffle ticket is purchased from the first price category and the raffle number is then randomly selected as a winning raffle number in the initial raffle game, and a second known portion of the initial raffle prize that is won if the raffle ticket is purchased from the second price category and the raffle number is then randomly selected as a winning raffle number in the initial raffle game, the second known portion of the initial raffle prize being less than the first known portion of the initial raffle prize;
indicating, prior to purchase of the raffle ticket, a first known portion of the subsequent raffle prize that is won if the raffle ticket is purchased from the first price category and the raffle number is then randomly selected as a winning raffle number in the subsequent raffle game, and a second known portion of the subsequent raffle prize that is won if the raffle ticket is purchased from the second price category and the raffle number is then randomly selected as a winning raffle number in the subsequent raffle game, the second known portion of the subsequent raffle prize being less than the first known portion of the subsequent raffle prize;
initiating play of the initial raffle game during the initial time period;
determining whether a player having a raffle ticket with the winning raffle number in the initial raffle game is awarded the first known portion of the initial raffle prize or the second known portion of the initial raffle prize based on which price category the player purchased the raffle ticket from;
initiating play of the subsequent raffle game during the subsequent time period; and
determining whether a player having a raffle ticket with the winning raffle number in the subsequent raffle game is awarded the first known portion of the subsequent raffle prize or the second known portion of the subsequent raffle prize based on which price category the player purchased the raffle ticket from.

27. The method of claim 26, wherein the raffle prize is a known fixed prize.

28. The method of claim 26, wherein the raffle prize is a progressive prize.

29. A method comprising:
indicating a first price category and a second price category in which a raffle ticket having a raffle number thereon is available for purchase, the raffle ticket being eligible for play in both an initial raffle game and a subsequent raffle game, the raffle number being utilized for play in both the initial raffle game and the subsequent raffle game, the initial raffle game occurring during an initial time period and the subsequent raffle game occurring during a subsequent time period, the initial raffle game having an initial raffle game prize associated therewith, the subsequent raffle game having a subsequent raffle prize associated therewith, the subsequent raffle game prize being less than the initial raffle game prize;
indicating, prior to purchase of the raffle ticket, a first known percentage corresponding to the first price category;
indicating, prior to purchase of the raffle ticket, a second known percentage corresponding to the second price category;
initiating play of the initial raffle game during the initial time period;
selecting, from the first known percentage and the second known percentage, a percentage of the initial raffle game prize to be awarded to a player having a raffle ticket with the winning raffle number in the initial raffle game;
initiating play of the subsequent raffle game during the subsequent time period; and
selecting, from the first known percentage and the second known percentage, a percentage of the subsequent raffle game prize to be awarded to a player having a raffle ticket with the winning raffle number in the subsequent raffle.

30. The method of claim 29, wherein the raffle prize is a known fixed prize.

31. The method of claim 29, wherein the raffle prize is a progressive prize.

32. A method comprising:
indicating a first price category and a second price category in which a raffle ticket having a raffle number thereon is available for purchase, the raffle ticket being eligible for play in both an initial raffle game and a subsequent raffle game, the raffle number being utilized for play in both the initial raffle game and the subsequent raffle game, the initial raffle game occurring during an initial time period and the subsequent raffle game occurring during a subsequent time period, the initial raffle game having an initial raffle game prize associated therewith, the subsequent raffle game having a subsequent raffle prize associated therewith, the subsequent raffle game prize being more than the initial raffle game prize;
indicating, prior to purchase of the raffle ticket, a first known percentage corresponding to the first price category;
indicating, prior to purchase of the raffle ticket, a second known percentage corresponding to the second price category;
initiating play of the initial raffle game during the initial time period;
selecting, from the first known percentage and the second known percentage, a percentage of the initial raffle game prize to be awarded to a player having a raffle ticket with the winning raffle number in the initial raffle game;
initiating play of the subsequent raffle game during the subsequent time period; and
selecting, from the first known percentage and the second known percentage, a percentage of the subsequent raffle game prize to be awarded to a player having a raffle ticket with the winning raffle number in the subsequent raffle.

33. The method of claim 32, wherein the raffle prize is a known fixed prize.

34. The method of claim 32, wherein the raffle prize is a progressive prize.

35. A system comprising:
a display module that indicates a first price category and a second price category in which a raffle ticket having a raffle number thereon is available for purchase, a first known percentage corresponding to the first price category, and a second known percentage corresponding to the first price category, the raffle ticket being eligible for play in both an initial raffle game and a subsequent raffle game, the raffle number being utilized for play in both the initial raffle game and the subsequent raffle game, the initial raffle game occurring during an initial time period and the subsequent raffle game occurring during a subsequent time period, the initial raffle game having an initial raffle game prize associated therewith, the subsequent raffle game having a subsequent raffle prize associated therewith, the subsequent raffle game prize being less than the initial raffle game prize; and
a controller that initiates play of the initial raffle game during the initial time period and selects, from the first known percentage and the second known percentage, a percentage of the initial raffle game prize to be awarded to a player having a raffle ticket with the winning raffle number in the initial raffle game, and initiates play of the subsequent raffle game during the subsequent time period and selects, from the first known percentage and the second known percentage, a percentage of the subsequent raffle game prize to be awarded to a player having a raffle ticket with the winning raffle number in the subsequent raffle game raffle game.

36. The system of claim 35, wherein the raffle prize is a known fixed prize.

37. The system of claim 35, wherein the raffle prize is a progressive prize.

38. A system comprising:
a display module that indicates a first price category and a second price category in which a raffle ticket having a raffle number thereon is available for purchase, a first known percentage corresponding to the first price category, and a second known percentage corresponding to the first price category, the raffle ticket being eligible for play in both an initial raffle game and a subsequent raffle game, the raffle number being utilized for play in both the initial raffle game and the subsequent raffle game, the initial raffle game occurring during an initial time period and the subsequent raffle game occurring during a subsequent time period, the initial raffle game having an initial raffle game prize associated therewith, the subsequent raffle game having a subsequent raffle prize associated therewith, the subsequent raffle game prize being more than the initial raffle game prize; and
a controller that initiates play of the initial raffle game during the initial time period and selects, from the first known percentage and the second known percentage, a percentage of the initial raffle game prize to be awarded to a player having a raffle ticket with the winning raffle number in the initial raffle game, and initiates play of the subsequent raffle game during the subsequent time period and selects, from the first known percentage and the second known percentage, a percentage of the subsequent raffle game prize to be awarded to a player having a raffle ticket with the winning raffle number in the subsequent raffle game raffle game.

39. The system of claim 38, wherein the raffle prize is a known fixed prize.

40. The system of claim 38, wherein the raffle prize is a progressive prize.

41. A computer program product comprising a computer useable medium having a computer readable program, wherein the computer readable program when executed on a computer causes the computer to:
indicate a first price category and a second price category in which a raffle ticket having a raffle number thereon is available for purchase, the raffle ticket being eligible for play in both an initial raffle game and a subsequent raffle game, the raffle number being utilized for play in both the initial raffle game and the subsequent raffle game, the initial raffle game occurring during an initial time period and the subsequent raffle game occurring during a subsequent time period, the initial raffle game having an initial raffle game prize associated therewith, the subsequent raffle game having a subsequent raffle prize associated therewith, the subsequent raffle game prize being less than the initial raffle game prize;
indicate, prior to purchase of the raffle ticket, a first known percentage corresponding to the first price category;
indicate, prior to purchase of the raffle ticket, a second known percentage corresponding to the second price category;
initiate play of the initial raffle game during the initial time period;
select, from the first known percentage and the second known percentage, a percentage of the initial raffle game prize to be awarded to a player having a raffle ticket with the winning raffle number in the initial raffle game;
initiate play of the subsequent raffle game during the subsequent time period; and
select, from the first known percentage and the second known percentage, a percentage of the subsequent raffle game prize to be awarded to a player having a raffle ticket with the winning raffle number in the subsequent raffle game.

42. The computer program product of claim 41, wherein the raffle prize is a known fixed prize.

43. The computer program product of claim 41, wherein the raffle prize is a progressive prize.

44. A computer program product comprising a computer useable medium having a computer readable program, wherein the computer readable program when executed on a computer causes the computer to:
indicate a first price category and a second price category in which a raffle ticket having a raffle number thereon is available for purchase, the raffle ticket being eligible for play in both an initial raffle game and a subsequent raffle game, the raffle number being utilized for play in both the initial raffle game and the subsequent raffle game, the initial raffle game occurring during an initial time period and the subsequent raffle game occurring during a subsequent time period, the initial raffle game having an initial raffle game prize associated therewith, the subsequent raffle game having a subsequent raffle prize associated therewith, the subsequent raffle game prize being less than the initial raffle game prize;
indicate, prior to purchase of the raffle ticket, a first known percentage corresponding to the first price category;
indicate, prior to purchase of the raffle ticket, a second known percentage corresponding to the second price category;
initiate play of the initial raffle game during the initial time period;
select, from the first known percentage and the second known percentage, a percentage of the initial raffle game prize to be awarded to a player having a raffle ticket with the winning raffle number in the initial raffle game;
initiate play of the subsequent raffle game during the subsequent time period; and
select, from the first known percentage and the second known percentage, a percentage of the subsequent raffle game prize to be awarded to a player having a raffle ticket with the winning raffle number in the subsequent raffle game.

45. The computer program product of claim 44, wherein the raffle prize is a known fixed prize.

46. The computer program product of claim 44, wherein the raffle prize is a progressive prize.
